(19) United States
(12) Patent Application Publication
(10) Pub. No.: US 2023/0278272 A1
(43) Pub. Date: Sep. 7, 2023

(54) INJECTION MOLDING MACHINE

(71) Applicant: FANUC CORPORATION, Minamitsuru-gun, Yamanashi (JP)

(72) Inventors: Ikuhiro MAKI, Minamitsuru-gun, Yamanashi-ken (JP); Masatoshi SENGA, Minamitsuru-gun, Yamanashi-ken (JP)

(73) Assignee: FANUC CORPORATION, Minamitsuru-gun, Yamanashi (JP)

(21) Appl. No.: 18/040,502

(22) PCT Filed: Aug. 2, 2021
(86) PCT No.: PCT/JP2021/028529

§ 371 Date: Feb. 3, 2023

(30) Foreign Application Priority Data
Aug. 7, 2020 (JP) 2020-134857

(51) Int. Cl. B29C 45/84; B29C 45/17

(52) U.S. Cl. CPC B29C 45/84; B29C 45/1774

(57) ABSTRACT

An injection molding machine comprises a safety door (first safety door, second safety door) for enabling an operator to access an inside mechanism (mold clamping mechanism, injection mechanism) when in an open state and preventing the operator from accessing the inside mechanism when in a closed state, the injection molding machine comprising: a display device for displaying an image; and a support mechanism (torque hinge) provided to the safety door, the support mechanism supporting the display device so as to make it possible to change the position or the orientation of the display device relative to the safety door.

### TECHNICAL FIELD

The present invention relates to an injection molding machine with a safety door.

### BACKGROUND ART

The injection molding machine includes a mold clamping device that clamps and opens a mold, and an injection device that injects a molten resin into the clamped mold. The mold clamping device and the injection device are arranged in a lateral direction. The periphery of the mold clamping device is covered with a cover. The periphery of the injection device is covered with a cover. An operation panel for inputting information to the mold clamping device and the injection device is attached to any one of these covers. Further, a display device for displaying various kinds of information is attached to one of the covers. JP H07-232364 A discloses an injection molding machine in which a display device is attached to a safety door constituting a part of the cover. In this injection molding machine, the operation panel is attached to a cover positioned lateral to the display device.

### SUMMARY OF THE INVENTION

There are cases where it may be difficult for an operator to view the display device when the operator operates the operation panel.

Therefore, an object of the present invention is to provide an injection molding machine capable of making it easy for an operator to view a display device.

According to an aspect of the present invention, there is provided an injection molding machine including a safety door configured to, in an open state thereof, allow an operator to access an internal mechanism that is inside the safety door and, in a closed state thereof, prevent the operator from accessing the internal mechanism, the injection molding machine further including: a display device configured to display an image; and a support mechanism provided on the safety door and configured to support the display device in a manner so that an orientation or a position of the display device with respect to the safety door is changeable.

According to the invention, the display device can be easily viewed by the operator.

### BRIEF DESCRIPTION OF DRAWINGS

FIG. 1 is an external view of an injection molding machine;

FIG. 2 is a block diagram of an injection molding machine;

FIG. 3 is a front view of a second safety door according to a first embodiment;

FIG. 4A is a front view of a bracket according to the first embodiment;

FIG. 4B is a right side view of the bracket according to the first embodiment;

FIG. 4C is a plan view of the bracket according to the first embodiment;

FIG. 5A is a rear view of a display device according to the first embodiment;

FIG. 5B is a left side view of the display device according to the first embodiment;

FIG. 6A is a rear view of a torque hinge according to the first embodiment;

FIG. 6B is a left side view of the torque hinge according to the first embodiment;

FIG. 6C is a plan view of the torque hinge according to the first embodiment;

FIG. 7 is a left side view of the display device attached to an accommodating portion of the second safety door in the first embodiment;

FIG. 8 is a front view of a second safety door according to a second embodiment;

FIG. 9 is a front view of a torque hinge according to the second embodiment;

FIG. 10 is a front view of a second safety door according to a third embodiment;

FIG. 11A is a front view of a torque hinge according to the third embodiment; and

FIG. 11B is a right side view of the torque hinge according to the third embodiment.

### DETAILED DESCRIPTION OF THE INVENTION

Preferred embodiments of the injection molding machine according to the present invention will be described in detail below with reference to the accompanying drawings.

### 1. Configuration of Injection Molding Machine 10

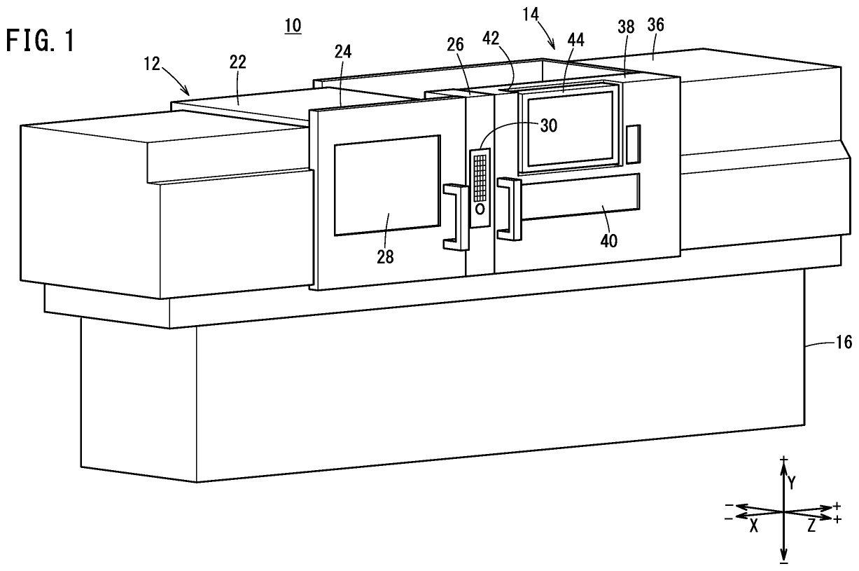

FIG. 1 is an external view of an injection molding machine 10. In the following description, a horizontal direction (longitudinal direction) of the injection molding machine 10 is defined as an X direction, a vertical direction (height direction) is defined as a Y direction, and a depth direction is defined as a Z direction. The Y direction is orthogonal to the X direction, and the Z direction is orthogonal to the X direction and the Y direction. In this specification, the +Z side of the injection molding machine 10 is referred to as the front side, and the −Z side of the injection molding machine 10 is referred to as the back side.

The injection molding machine 10 includes a mold clamping device 12 and an injection device 14. The mold clamping device 12 and the injection device 14 are mounted on a machine base 16 and are arranged from the +X direction toward the −X direction. The mold clamping device 12 is disposed on the −X side of the injection molding machine 10. The injection device 14 is disposed on the +X side of the injection molding machine 10.

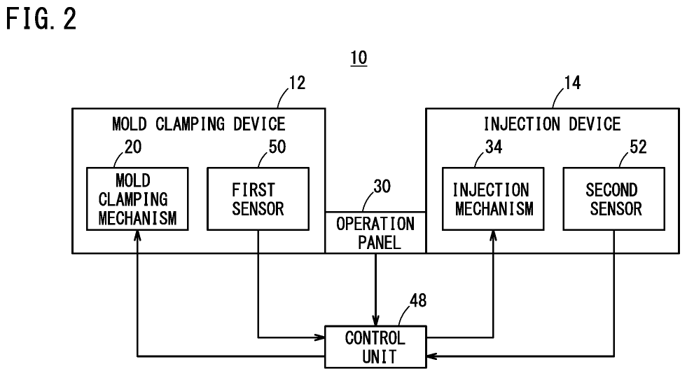

The mold clamping device 12 includes a mold clamping mechanism 20 (FIG. 2) that performs mold clamping and mold opening. The mold clamping mechanism 20 is covered with a first cover 22. The first cover 22 covers the mold clamping mechanism 20 in the −X direction, the +Y direction, and the ±Z directions. A portion of the first cover 22 located in the +Z direction has an opening. The opening is covered with a first safety door 24. The first safety door 24 is horizontally movable in the +X direction and the −X direction. The first safety door 24 closes the opening of the mold clamping device 12 by stopping at a terminal position on the +X side in the movable range. Thus, the first safety door 24 prevents an operator from accessing the mold. The first safety door 24 opens the opening of the mold clamping device 12 by moving in the −X direction from the terminal position on the +X side. Thus, the first safety door 24 allows an operator to access the mold. The first safety door 24 is provided with a first window 28 having a transparent member fitted therein.

A stationary platen cover 26 is disposed adjacent to the first safety door 24 in the +X direction of the first safety door 24. An operation panel 30 is attached to the front surface of the stationary platen cover 26. The operation panel 30 is an input device for inputting operation information for the mold clamping mechanism 20 and operation information for an injection mechanism 34, to a control unit 48 (FIG. 2).

The injection device 14 includes an injection mechanism 34 (FIG. 2) that injects molten resin into the mold of the mold clamping device 12. The injection mechanism 34 is covered with a second cover 36. The second cover 36 covers the injection mechanism 34 in the +X direction, the +Y direction, and the ±Z direction. A portion of the second cover 36 located in the +Z direction has an opening. The opening is covered with a second safety door 38. The second safety door 38 is horizontally movable in the −X direction and the +X direction. The second safety door 38 closes the opening of the injection device 14 by stopping at a terminal position on the -X side in the movable range. Thus, the second safety door 38 prevents an operator from accessing a nozzle, a cylinder, etc. The second safety door 38 opens the opening of the injection device 14 by moving in the +X direction from the terminal position on the −X side. Thus, the second safety door 38 allows an operator to access the nozzle, the cylinder, etc. The second safety door 38 is provided with a second window 40 having a transparent member fitted therein.

A +Z side portion of the second safety door 38 includes an accommodating portion 42 formed therein so as to be recessed in the −Z direction from the front surface of the second safety door 38. A display device 44 for displaying an image regarding the operation of the injection molding machine 10 is accommodated in the accommodating portion 42. The screen of the display device 44 is exposed so as to face in the +Z direction. The display device 44 is supported by a support mechanism inside the accommodating portion 42. The support mechanism will be described later.

### 2. System Configuration of Injection Molding Machine 10

FIG. 2 is a block diagram of the injection molding machine 10. The control unit 48 includes a processor (not illustrated) such as a CPU. The control unit 48 includes various memories (not shown) such as a RAM, a ROM, a hard disk, etc. The control unit 48 controls the operation of the mold clamping mechanism 20 and the operation of the injection mechanism 34 based on a program stored in advance, operation information input by the operation panel 30, and the like.

A first sensor 50 is provided in the mold clamping device 12. The first sensor 50 detects whether the first safety door 24 is in an open state or in a closed state. The first sensor 50 detects the open state of the first safety door 24 and outputs an open signal to the control unit 48. The open signal is a signal indicating that the first safety door 24 is in the open state. When the open signal is supplied from the first sensor 50, the control unit 48 stops all operations of the injection molding machine 10 or a predetermined operation of the injection molding machine 10.

A second sensor 52 is provided in the injection device 14. The second sensor 52 detects whether the second safety door 38 is in an open state or in a closed state. The second sensor 52 detects the open state of the second safety door 38 and outputs an open signal to the control unit 48. The open signal is a signal indicating that the second safety door 38 is in the open state. When the open signal is supplied from the second sensor 52, the control unit 48 stops all operations of the injection molding machine 10 or a predetermined operation of the injection molding machine 10.

### 3. Support Mechanism

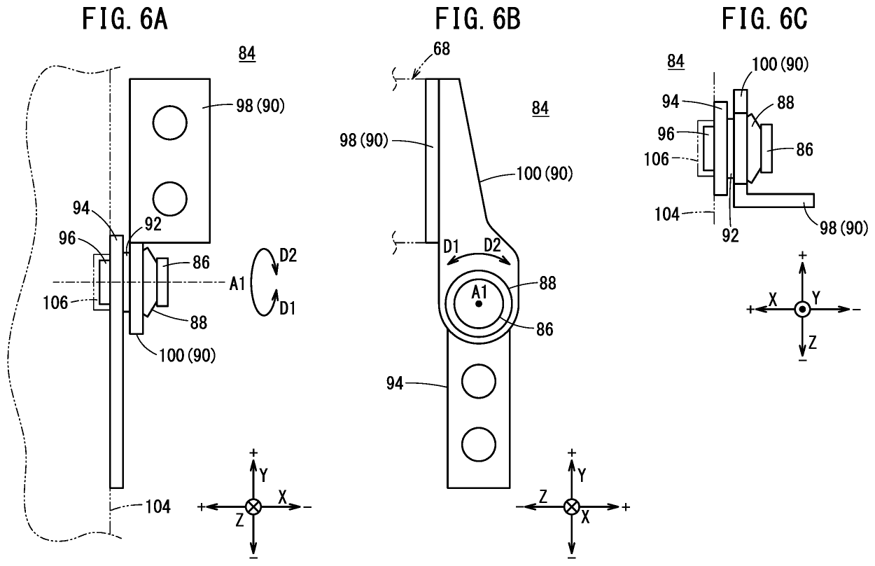

A torque hinge 84 is used as a support mechanism for supporting the display device 44 inside the accommodating portion 42. The torque hinge 84 is shown in FIGS. 6A to 6C, 9, 11A, and 11B. The torque hinge 84 allows the orientation of the display device 44 relative to the second safety door 38 to be changeable. Hereinafter, the torque hinge 84, the structure of the second safety door 38 to which the torque hinge 84 is attached, and the structure of the display device 44 will be described.

### 3-1. First Embodiment

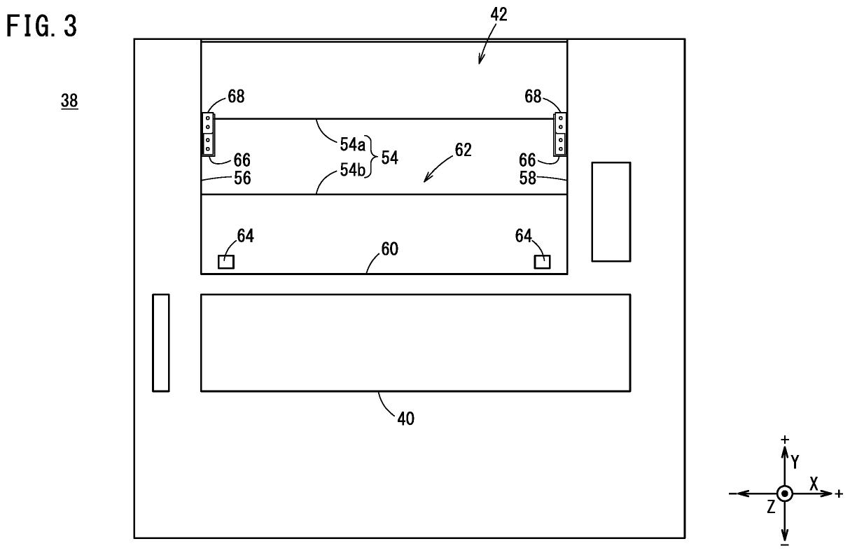

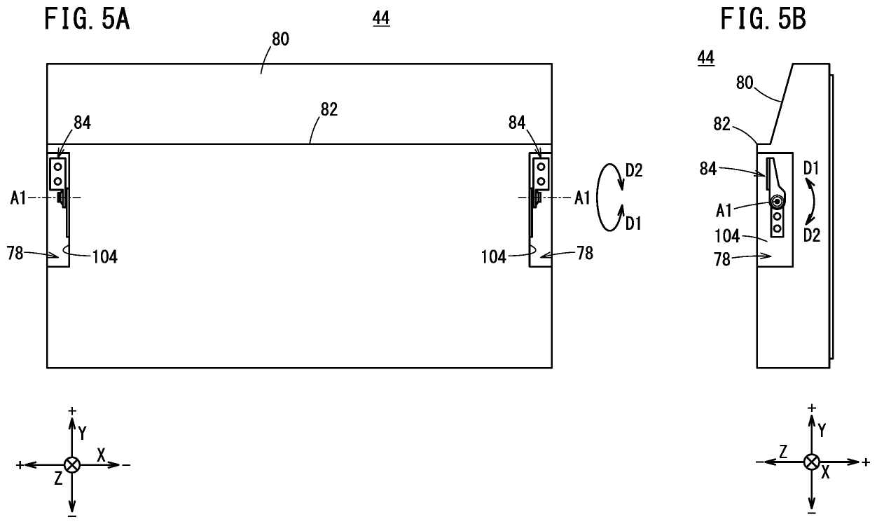

The first embodiment will be described with reference to FIGS. 3 to 7. In the first embodiment, the display device 44 is rotatable with respect to the second safety door 38 about an axis Al (FIGS. 5A and 5B) extending in the X direction (the horizontal direction).

FIG. 3 is a front view of the second safety door 38 of the first embodiment. FIG. 3 shows the second safety door 38 without the display device 44 attached thereto. As shown in FIG. 3, the accommodating portion 42 is provided above the second window 40. The accommodating portion 42 is formed by a rear inner wall 54 on the −Z side, a left inner wall 56 on the −X side, a right inner wall 58 on the +X side, and a bottom inner wall 60 on the −Y side. The rear inner wall 54 is parallel to the X-Y plane. The left inner wall 56 and the right inner wall 58 are parallel to the Y-Z plane. The bottom inner wall 60 is parallel to the X-Z plane. There is no inner wall on the +Y side of the accommodating portion 42. The +Y side of the accommodating portion 42 is open.

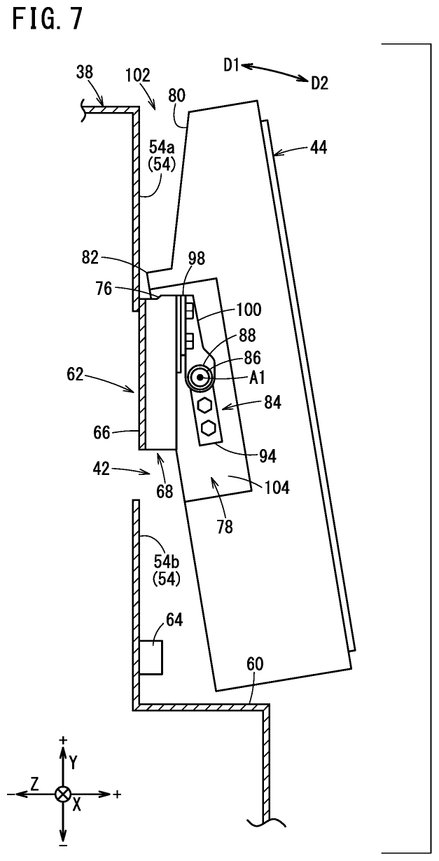

The rear inner wall 54 is formed with an opening 62 that divides the rear inner wall 54 into a +Y side portion and a −Y side portion. The +Y side portion of the rear inner wall 54 is an upper inner wall 54a. The −Y side portion of the rear inner wall 54 is a lower inner wall 54b. The upper inner wall 54a and the lower inner wall 54b are spaced apart from each other. The lower inner wall 54b is provided with a rotation limiting portion 64 that protrudes in the +Z direction. The rotation limiting portion 64 limits one-direction rotation of the display device 44 (the D2 direction in FIG. 7).

The left inner wall 56 is provided with a plate-shaped bracket support portion 66. The bracket support portion 66 of the left inner wall 56 protrudes in the +X direction. Similarly, the right inner wall 58 is provided with a plate-shaped bracket support portion 66. The bracket support portion 66 of the right inner wall 58 protrudes in the −X direction. When viewed from the +Z direction, a part of the bracket support portion 66 or the whole of the bracket support portion 66 overlaps the opening 62. The bracket support portion 66 supports a bracket 68.

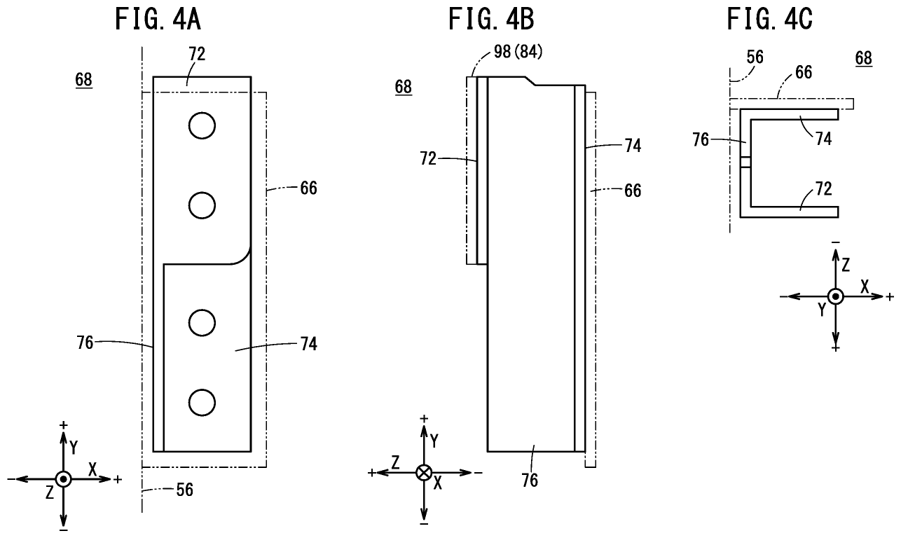

FIG. 4A is a front view of the bracket 68 according to the first embodiment. FIG. 4B is a right side view of the bracket 68 according to the first embodiment. FIG. 4C is a plan view of the bracket 68 according to the first embodiment. FIGS. 4A to 4C show the bracket 68 on the −X side (left side) of the two brackets 68. The structure of the bracket 68 provided on the +X side (right side) and the structure of the bracket 68 provided on the −X side (left side) are reversed on the left and right.

The bracket 68 includes a bracket front plate 72, a bracket rear plate 74, and a bracket side plate 76. The bracket front plate 72 and the bracket rear plate 74 are parallel to the X-Y plane. The bracket front plate 72 is located on the +Z side relative to the bracket rear plate 74. The bracket front plate 72 supports the torque hinge 84 (FIG. 5A and the like). The bracket rear plate 74 is located on the -Z side relative to the bracket front plate 72. The bracket rear plate 74 is positioned on the +Z side relative to the bracket support portion 66. The bracket rear plate 74 is fixed to the bracket support portion 66 by bolts or the like. The bracket side plate 76 is interposed between the bracket front plate 72 and the bracket rear plate 74.

FIG. 5A is a rear view of the display device 44 according to the first embodiment. FIG. 5B is a left side view of the display device 44 according to the first embodiment. The display device 44 includes a recessed portion 78 formed therein so as to be recessed in the +Z direction from the back surface of the display device 44. The recessed portion 78 is formed at each of the intersection of the back surface and the right side surface of the display device 44 and the intersection of the back surface and the left side surface of the display device 44. The torque hinge 84 is fixed to each of the recessed portion 78 on the +X side and the recessed portion 78 on the −X side. As shown in FIG. 5B, an inclined portion 80 recessed in the +Z direction from the back surface of the display device 44 is formed at the +Y side end portion of the back surface of the display device 44.

FIG. 6A is a rear view of the torque hinge 84 of the first embodiment. FIG. 6B is a left side view of the torque hinge 84 of the first embodiment. FIG. 6C is a plan view of the torque hinge 84 of the first embodiment. FIGS. 6A to 6C show the torque hinge 84 on the −X side (left side) of the two torque hinges 84. The structure of the torque hinge 84 provided on the +X side (right side) and the structure of the torque hinge 84 provided on the −X side (left side) are reversed on the left and right.

The torque hinge 84 includes a rotation shaft (rotary axis) 86, a disc spring 88, a fixed plate 90, a spacer 92, a rotating plate 94, and a nut 96. The rotation shaft 86 is a bolt centered on the axis A1. A screw (not shown) of the rotation shaft 86 is inserted through the disc spring 88, the fixed plate 90, the spacer 92, and the rotating plate 94 in this order. The screw of the rotation shaft 86 is screwed into the nut 96. The disc spring 88, the fixed plate 90, the spacer 92, and the rotating plate 94 are held between the head of the rotation shaft 86 and the nut 96.

The disc spring 88 applies an appropriate axial force to the fixed plate 90, the spacer 92, and the rotating plate 94. The appropriate axial force is a force that can maintain the rotation angle of the rotating plate 94 with respect to the fixed plate 90 unless a force equal to or greater than a predetermined value is applied to the rotation plate 94 in the rotation direction (D1 or D2). Further, the appropriate axial force is also a force that allows the rotation angle of the rotating plate 94 relative to the fixed plate 90 to be changed when a force equal to or greater than the predetermined value is applied to the rotating plate 94 in the rotation direction.

The fixed plate 90 has a rear plate 98 and a side plate 100. As shown in FIG. 6C, when viewed from the +Y direction, the rear plate 98 and the side plate 100 form an L shape. The rear plate 98 is parallel to the X-Y plane. The rear plate 98 is located on the −Z side of the side plate 100. The rear plate 98 is fixed to the bracket front plate 72, which is a +Z side portion of the bracket 68. The rear plate 98 is fixed to the bracket front plate 72 by bolts or the like. The side plate 100 is parallel to the Y-Z plane. A hole (not illustrated) is formed in the −Y side end portion of the side plate 100. The screw (not shown) of the rotation shaft 86 is inserted into the hole. A portion around the hole is sandwiched between the disc spring 88 and the spacer 92.

The rotating plate 94 is a flat plate parallel to the Y-Z plane. A hole (not illustrated) is formed in the +Y side end portion of the rotating plate 94. The screw (not shown) of the rotation shaft 86 is inserted into the hole. A portion around the hole is sandwiched between the spacer 92 and the nut 96. The rotating plate 94 is fixed to a wall surface 104 parallel to the Y-Z plane of the inner walls of the recessed portion 78 of the display device 44 by bolts or the like. Note that a hole 106 is formed in the wall surface 104 parallel to the Y-Z plane. The nut 96 is inserted into the hole 106.

FIG. 7 is a left side view of the display device 44 attached to the accommodating portion 42 of the second safety door 38 in the first embodiment. FIG. 7 shows a state in which the display device 44 is rotated in the D1 direction. The display device 44 is attached to the accommodating portion 42 of the second safety door 38 via the torque hinge 84 and the bracket 68. In this state, a gap is provided between the rear inner wall 54 of the accommodating portion 42 and the display device 44 to the extent that the display device 44 can rotate. When the operator applies a force equal to or larger than a predetermined value to the display device 44 in the D1 direction or the D2 direction, the torque hinge 84 allows the display device 44 to rotate about the rotation shaft (rotary axis) 86 (the axis A1). As described above, according to the first embodiment, since the orientation of the display device 44 can be adjusted, it is possible to make the display device 44 easily viewable to the operator.

When the operator stops the angle adjustment of the display device 44, the torque hinge 84 maintains the rotation angle of the display device 44 at the rotation angle that the operator has adjusted. As described above, according to the first embodiment, since the rotation angle of the display device 44 can be maintained, the viewability of the display device 44 for the operator can be maintained.

When the display device 44 rotates in the D1 direction and the rotation angle reaches a predetermined first angle, an abutting portion 82 (for example, a part of the back surface) of the display device 44 comes into contact with the upper inner wall 54a of the accommodating portion 42. Thus, the rotation of the display device 44 in the D1 direction is limited. At this time, a clearance 102 corresponding to the recess of the inclined portion 80 is formed between the +Y side edge of the display device 44 and the upper inner wall 54a. In addition, when the display device 44 rotates in the D2 direction and the rotation angle reaches a predetermined second angle (<the first angle), the back surface of the display device 44 comes into contact with the rotation limiting portion 64 of the accommodating portion 42. Thus, the rotation of the display device 44 in the D2 direction is limited.

### 3-2. Second Embodiment

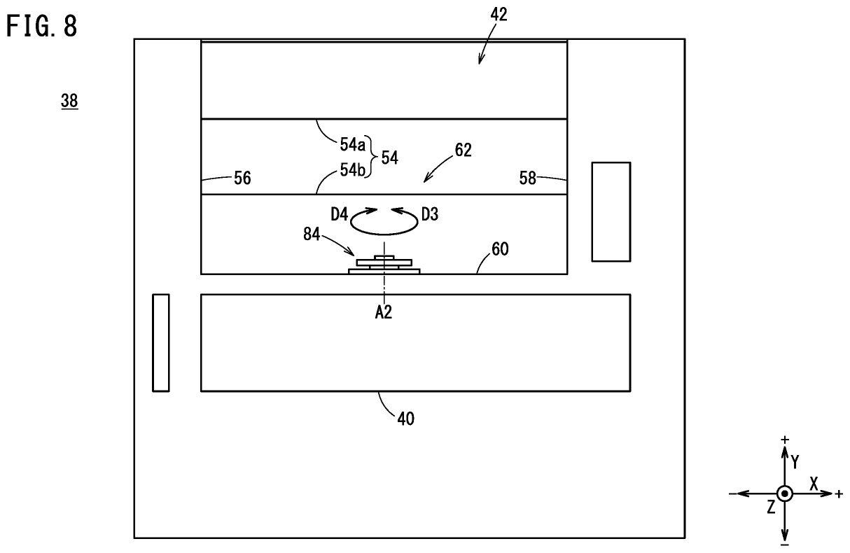

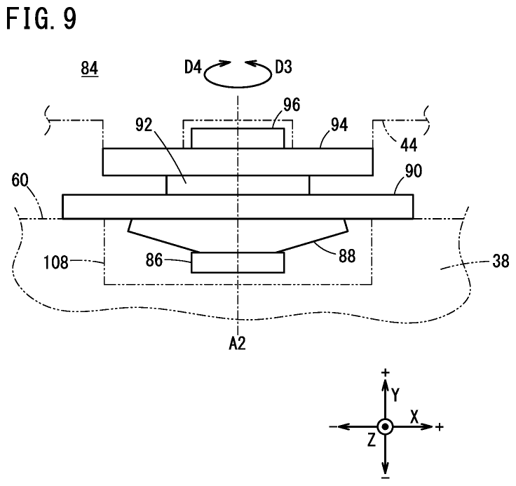

The second embodiment will be described with reference to FIGS. 8 and 9. In the second embodiment, the display device 44 is rotatable relative to the second safety door 38 about an axis A2 extending in the Y direction (vertical direction).

FIG. 8 is a front view of the second safety door 38 according to the second embodiment. FIG. 8 shows the second safety door 38 without the display device 44 attached thereto. In FIG. 8, the same components as those of the second safety door 38 shown in FIG. 3 are denoted by the same reference numerals. A torque hinge 84 is attached to the bottom inner wall 60. The second safety door 38 of the second embodiment supports the display device 44 on the bottom inner wall 60.

FIG. 9 is a front view of the torque hinge 84 according to the second embodiment. Hereinafter, concerning the torque hinge 84 of the second embodiment, portions different from the torque hinge 84 of the first embodiment will be described.

The rotation shaft 86 is a bolt centered on the axis A2. The screw (not illustrated) of the rotation shaft 86 is inserted through the disc spring 88, the fixed plate 90, the spacer 92, and the rotating plate 94 in this order from the −Y direction. The screw of the rotation shaft 86 is screwed into the nut 96.

The fixed plate 90 is a flat plate parallel to the X-Z plane. The shape of the flat plate is a circle or the like. The screw (not shown) of the rotation shaft 86 is inserted through the center of the fixed plate 90. The fixed plate 90 is sandwiched between the disc spring 88 and the spacer 92. The fixed plate 90 is fixed to the +Y side surface of the bottom inner wall 60 with bolts or the like. A hole 108 is formed in the bottom inner wall 60. The head of the rotation shaft 86 and the disc spring 88 are positioned in the hole 108.

The rotating plate 94 is a flat plate parallel to the X-Z plane. The shape of the flat plate is a circle or the like. The screw (not shown) of the rotation shaft 86 is inserted through the center of the rotating plate 94. The rotating plate 94 is sandwiched between the spacer 92 and the nut 96. The rotating plate 94 is fixed to a metal fitting or the like provided on the bottom surface side of the display device 44 with bolts or the like.

The display device 44 is attached to the bottom inner wall 60 of the second safety door 38 via the torque hinge 84. In this state, a gap is provided between the rear inner wall 54 of the accommodating portion 42 and the display device 44 to the extent that the display device 44 can rotate. When the operator applies a force equal to or larger than a predetermined value to the display device 44 in the D3 direction or the D4 direction, the torque hinge 84 allows the display device 44 to rotate about the rotation shaft (rotary axis) 86 (the axis A2). As described above, according to the second embodiment, since the orientation of the display device 44 can be adjusted, it is possible to make the display device 44 easily viewable to the operator.

When the operator stops the angle adjustment of the display device 44, the torque hinge 84 maintains the rotation angle of the display device 44 at the rotation angle that the operator has adjusted. As described above, according to the second embodiment, since the rotation angle of the display device 44 can be maintained, the visibility of the display device 44 for the operator can be maintained.

### 3-3. Third Embodiment

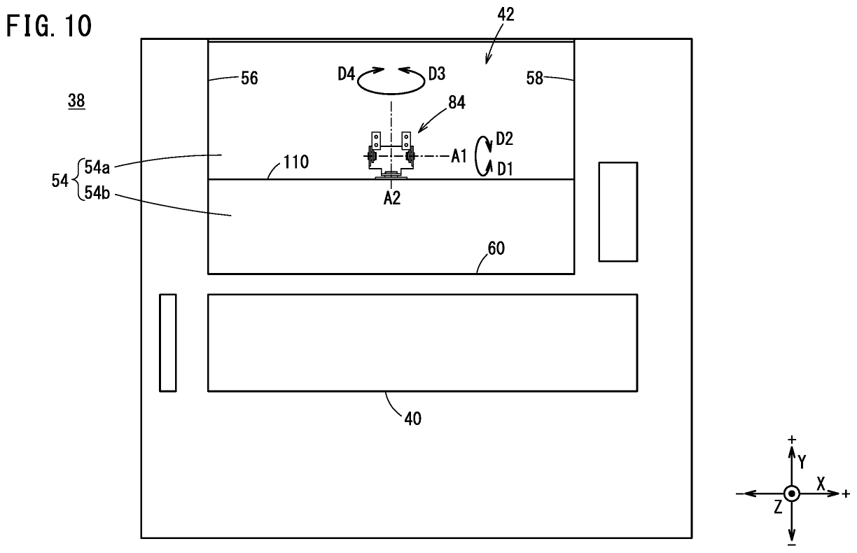

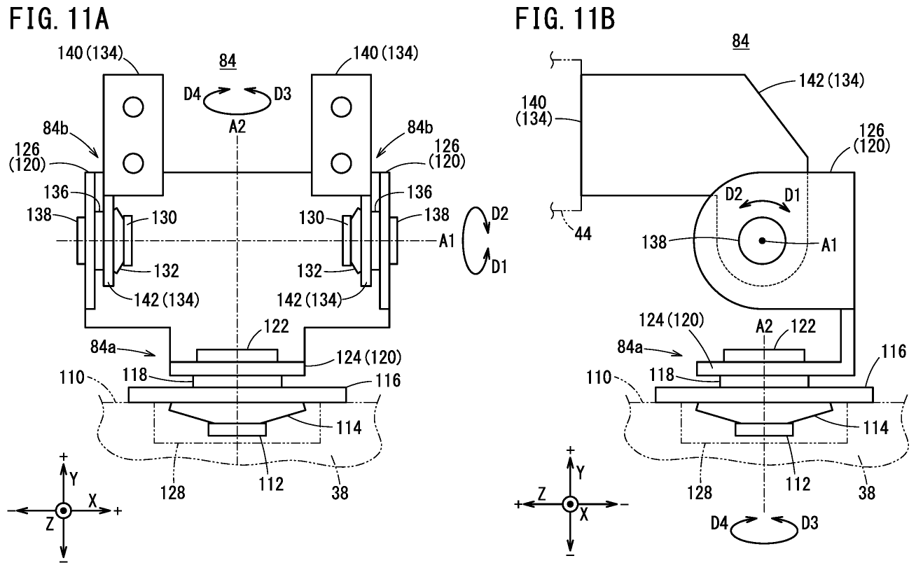

The third embodiment will be described with reference to FIGS. 10, 11A and 11B. In the third embodiment, the display device 44 is rotatable relative to the second safety door 38 about an axis Al extending in the X direction (the horizontal direction). Further, the display device 44 is also rotatable relative to the second safety door 38 about an axis A2 extending in the Y direction (vertical direction).

FIG. 10 is a front view of the second safety door 38 according to the third embodiment. FIG. 10 shows the second safety door 38 without the display device 44 attached thereto. In FIG. 10, the same components as those of the second safety door 38 shown in FIG. 3 are denoted by the same reference numerals.

As shown in FIG. 10, the accommodating portion 42 is defined by a rear inner wall 54, a left inner wall 56, a right inner wall 58, and a bottom inner wall 60. The rear inner wall 54 is formed with a step that divides the rear inner wall 54 into a +Y side portion and a −Y side portion. The step includes an intermediate inner wall 110. The intermediate inner wall 110 is parallel to the X-Z plane. The intermediate inner wall 110 is connected to a lower end of the upper inner wall 54a and an upper end of the lower inner wall 54b. The upper inner wall 54a is located behind (in the −Z direction) and above (in the +Y direction) the lower inner wall 54b. A torque hinge 84 is attached to the intermediate inner wall 110. The second safety door 38 of the third embodiment supports the display device 44 on the intermediate inner wall 110.

FIG. 11A is a front view of the torque hinge 84 of the third embodiment. FIG. 11B is a right side view of the torque hinge 84 of the third embodiment. The torque hinge 84 includes a first torque hinge 84a and two second torque hinges 84b. The first torque hinge 84a allows the display device 44 to rotate about the axis A2. The two second torque hinges 84b allow the display device 44 to rotate about the axis A1.

The first torque hinge 84a includes a first rotation shaft (first rotary axis) 112, a first disc spring 114, a first fixed plate 116, a first spacer 118, a first rotating plate 120, and a first nut 122. The first rotation shaft 112 is a bolt centered on the axis A2. The screw (not illustrated) of the first rotation shaft 112 is inserted through the first disc spring 114, the first fixed plate 116, the first spacer 118, and the first rotating plate 120 (the first bottom plate 124) in this order from the -Y direction. The screw (not shown) of the first rotation shaft 112 is screwed into the first nut 122. The first disc spring 114, the first fixed plate 116, the first spacer 118, and the first rotating plate 120 are held between the head of the first rotation shaft 112 and the first nut 122.

The first fixed plate 116 is a flat plate parallel to the X-Z plane. The shape of the flat plate is a circle or the like. The screw (not shown) of the first rotation shaft 112 is inserted through the center of the first fixed plate 116. The first fixed plate 116 is sandwiched between the first disc spring 114 and the first spacer 118. The first fixed plate 116 is fixed to the +Y side surface of the intermediate inner wall 110 with bolts or the like. A hole 128 is formed in the intermediate inner wall 110. The head of the first rotation shaft 112 and the first disc spring 114 are positioned in the hole 128.

The first rotating plate 120 is a member that connects the first torque hinge 84a and the two second torque hinges 84b. The first rotating plate 120 is formed by bending a flat plate. The first rotating plate 120 includes at least a first bottom plate 124 parallel to the X-Z plane and two first side plates 126 parallel to the Y-Z plane. Each of the two first side plates 126 is located on the +Y side in the first rotating plate 120. The first bottom plate 124 is located on the −Y side in the first rotating plate 120. The screw (not illustrated) of the first rotation shaft 112 is inserted through the first bottom plate 124. The first bottom plate 124 is sandwiched between the first spacer 118 and the first nut 122.

Each of the two second torque hinges 84b includes a second rotation shaft (second rotary axis) 130, a second disc spring 132, a second rotating plate 134, a second spacer 136, a first rotating plate 120, and a second nut 138. One second torque hinge 84b and the other second torque hinge 84b are arranged from the +X direction toward the -X direction.

The second rotation shaft 130 is a bolt centered on the axis A1. The screw (not illustrated) of the second rotation shaft 130 is inserted through the second disc spring 132, the second rotating plate 134, the second spacer 136, and the first rotating plate 120 (the first side plate 126) in this order. The screw of the second rotation shaft 130 is screwed into the second nut 138. The second disc spring 132, the second rotating plate 134, the second spacer 136, and the first rotating plate 120 (the first side plate 126) are held between the head of the second rotation shaft 130 and the second nut 138.

The second rotating plate 134 includes a second front plate 140 and a second side plate 142. Similarly to the rear plate 98 and the side plate 100 illustrated in FIG. 6C, the second front plate 140 and the second side plate 142 form an L shape when viewed from the +Y direction. The second front plate 140 is parallel to the X-Y plane. The second front plate 140 is connected to a +Z side end portion of the second side plate 142. The second front plate 140 is fixed to a metal fitting or the like provided on the back surface side of the display device 44 with bolts or the like. The second side plate 142 is parallel to the Y-Z plane. A hole (not illustrated) is formed in a −Y side end portion of the second side plate 142. The screw (not illustrated) of the second rotation shaft 130 is inserted into the hole. A portion around the hole is sandwiched between the second disc spring 132 and the second spacer 136.

The screw (not shown) of the second rotation shaft 130 is inserted through the first side plate 126 of the first rotating plate 120. The first side plate 126 is sandwiched between the second spacer 136 and the second nut 138.

The display device 44 is attached to the intermediate inner wall 110 of the second safety door 38 via the torque hinge 84. In this state, a gap is provided between the rear inner wall 54 of the accommodating portion 42 and the display device 44 to the extent that the display device 44 can rotate. When the operator applies a force equal to or larger than a predetermined value to the display device 44 in the D1 direction or the D2 direction, the two second torque hinges 84b allow the display device 44 to rotate about the second rotation shaft (second rotary axis) 130 (the axis A1). When the operator applies a force equal to or larger than a predetermined value to the display device 44 in the D3 direction or the D4 direction, the first torque hinge 84a allows the display device 44 to rotate about the first rotation shaft (first rotary axis) 112 (the axis A2). As described above, according to the third embodiment, since the direction of the display device 44 can be adjusted, it is possible to make the display device 44 easily viewable to the operator.

When the operator stops the angle adjustment of the display device 44, the first torque hinge 84a and the two second torque hinges 84b maintain the rotation angle of the display device 44 at the rotation angle that the operator has adjusted. As described above, according to the third embodiment, since the rotation angle of the display device 44 can be maintained, the viewability of the display device 44 for the operator can be maintained.

When the display device 44 rotates in the D1 direction and the rotation angle reaches a predetermined first angle, the abutting portion 82 (FIG. 7) of the display device 44 comes into contact with the upper inner wall 54a of the accommodating portion 42. Thus, the rotation of the display device 44 in the D1 direction is limited. At this time, a clearance 102 (FIG. 7) corresponding to the recess of the inclined portion 80 is formed between the +Y side edge of the display device 44 and the second safety door 38.

### 4. Other Embodiments

In the above-described embodiments, the torque hinge 84 is used as the support mechanism in order to make changeable the orientation of the display device 44 relative to the second safety door 38. Alternatively, the position of the display device 44 may be changeable relative to the second safety door 38. In this case, a guide rail may be used as the support mechanism.

In the above embodiments, the display device 44 is attached to the second safety door 38. Alternatively, the display device 44 may be attached to the first safety door 24.

### 5. Invention Obtained from Embodiments

The invention graspable from the embodiments described above will be recited below.

An aspect of the present invention is characterized by the injection molding machine (10) including the safety door (38, 24) configured to, in the open state, allow the operator to access the internal mechanism (20, 34) that is inside the safety door and, in the closed state, prevent the operator from accessing the internal mechanism, the injection molding machine further including: the display device (44) configured to display an image; and the support mechanism (84) provided on the safety door and configured to support the display device such that the orientation or the position of the display device with respect to the safety door is changeable.

In the aspect of the present invention, the support mechanism may include the rotary axis (86, 112, 130) parallel to the vertical direction (the Y direction) or the horizontal direction (the X direction) of the safety door, and may support the display device in a manner so that the rotation angle of the display device with respect to the safety door about the rotary axis is changeable.

In the aspect of the present invention, the support mechanism may include the first rotary axis (112) parallel to the vertical direction (the Y direction) of the safety door and the second rotary axis (130) parallel to the horizontal direction (the X direction) of the safety door, and may support the display device in a manner so that the rotation angles of the display device with respect to the safety door about the first rotary axis and the second rotary axis are changeable.

In the aspect of the present invention, the display device may include the abutting portion (82) on the back surface opposite to the screen, the abutting portion (82) being configured to, when the display device rotates by a predetermined angle, come into contact with the safety door to thereby limit the rotation angle of the display device with respect to the safety door, and the clearance (102) may be formed between the edge of the back surface of the display device and the safety door in a state where the rotation angle of the display device reaches the predetermined angle by the abutting portion being in contact with the safety door.

In the aspect of the present invention, the support mechanism may be the hinge (84) configured to maintain the rotation angle of the display device with respect to the safety door at the rotation angle after the adjustment performed by the operator.

The configuration of the injection molding machine according to the present invention is not limited to those of the embodiments described above but can adopt various configurations without departing from the essence and gist of the present invention.

1. An injection molding machine comprising a safety door configured to, in an open state thereof, allow an operator to access an internal mechanism that is inside the safety door and, in a closed state thereof, prevent the operator from accessing the internal mechanism, the injection molding machine further comprising:
a display device configured to display an image; and
a support mechanism provided on the safety door and configured to support the display device in a manner so that an orientation or a position of the display device with respect to the safety door is changeable.

2. The injection molding machine according to claim 1, wherein
the support mechanism includes a rotary axis parallel to a vertical direction or a horizontal direction of the safety door, and supports the display device in a manner so that a rotation angle of the display device with respect to the safety door about the rotary axis is changeable.

3. The injection molding machine according to claim 1, wherein
the support mechanism includes a first rotary axis parallel to a vertical direction of the safety door and a second rotary axis parallel to a horizontal direction of the safety door, and supports the display device in a manner so that rotation angles of the display device with respect to the safety door about the first rotary axis and the second rotary axis are changeable.

4. The injection molding machine according to claim 2, wherein
the display device includes an abutting portion on a back surface thereof opposite to a screen thereof, the abutting portion being configured to, when the display device rotates by a predetermined angle, come into contact with the safety door to thereby limit the rotation angle of the display device with respect to the safety door, and
a clearance is formed between an edge of the back surface of the display device and the safety door in a state where the rotation angle of the display device reaches the predetermined angle by the abutting portion being in contact with the safety door.

5. The injection molding machine according to claim 3, wherein
the display device includes an abutting portion on a back surface thereof opposite to a screen thereof, the abutting portion being configured to, when the display device rotates by a predetermined angle, come into contact with the safety door to thereby limit the rotation angle of the display device with respect to the safety door, and
a clearance is formed between an edge of the back surface of the display device and the safety door in a state where the rotation angle of the display device reaches the predetermined angle by the abutting portion being in contact with the safety door.

6. The injection molding machine according to claim 2, wherein
the support mechanism is a hinge configured to maintain the rotation angle of the display device with respect to the safety door at a rotation angle after adjustment performed by the operator.

7. The injection molding machine according to claim 3, wherein
the support mechanism is a hinge configured to maintain the rotation angle of the display device with respect to the safety door at a rotation angle after adjustment performed by the operator.

8. The injection molding machine according to claim 4, wherein
the support mechanism is a hinge configured to maintain the rotation angle of the display device with respect to the safety door at a rotation angle after adjustment performed by the operator.

9. The injection molding machine according to claim 5, wherein
the support mechanism is a hinge configured to maintain the rotation angle of the display device with respect to the safety door at a rotation angle after adjustment performed by the operator.
